(19) United States
(12) Patent Application Publication
(10) Pub. No.: US 2021/0303878 A1
(43) Pub. Date: Sep. 30, 2021

(54) OBSTACLE DETECTION APPARATUS, OBSTACLE DETECTION METHOD, AND PROGRAM

(71) Applicant: AISIN SEIKI KABUSHIKI KAISHA, Kariya-shi (JP)

(72) Inventor: Atsushi HORI, Kariya-shi (JP)

(73) Assignee: AISIN SEIKI KABUSHIKI KAISHA, Kariya-shi (JP)

(21) Appl. No.: 17/189,930

(22) Filed: Mar. 2, 2021

(30) Foreign Application Priority Data
Mar. 30, 2020 (JP) 2020-059472

(51) Int. Cl. G06K 9/00; G06T 7/70; B60R 1/06; E05F 15/40

(52) U.S. Cl. CPC G06K 9/00805; G06T 7/70; B60R 1/06; E05Y 2900/531; G06T 2207/30261; E05Y 2400/54; E05F 15/40

(57) ABSTRACT

An obstacle detection apparatus incudes an operation control portion configured to control operation of a movable portion, a first obtaining portion configured to obtain captured image data from an imager provided at the movable portion, the captured image data including first captured image data when the movable portion is in a first state and second captured image data when the movable portion is in a second state, a second obtaining portion configured to obtain moving amount information of the movable portion, an imager position calculation portion configured to calculate imager position information including a position of the imager when the movable portion is in the first state and a position of the imager when the movable portion is in the second state, and an obstacle position calculation portion configured to calculate a three-dimensional position of an obstacle included in the first captured image data and the second captured image data.

### CROSS REFERENCE TO RELATED APPLICATIONS

This application is based on and claims priority under 35 U.S.C. § 119 to Japanese Patent Application 2020-059472, filed on Mar. 30, 2020, the entire content of which is incorporated herein by reference.

### TECHNICAL FIELD

This disclosure generally relates to an obstacle detection apparatus, an obstacle detection method, and program.

### BACKGROUND DISCUSSION

Recently, research and development of functions related to a vehicle including a passenger vehicle has been underway. Such functions include, for example, a door opening and closing function for automatically opening and closing a door of a vehicle, and/or a door collision avoidance function that prevents the door from colliding with an obstacle when the door is opened and closed by the door opening and closing function. In order to realize the door collision avoidance function, an obstacle detection function for detecting an obstacle existing within a range of an opening and closing operation of the door needs to be realized with high accuracy.

For example, the obstacle detection function may be realized on the basis of a detection result of a radio wave sensor, sonar (an ultrasonic apparatus), LiDAR (Light Detection and Ranging) and an electrostatic capacitance proximity sensor, and/or captured image data, by a vehicle-mounted camera, of a vicinity of a door at an outer side of the vehicle. In particular, a cost reduction can be achieved if the obstacle is detected on the basis of the captured image data captured by the vehicle-mounted camera because a camera is often mounted on the vehicle for other uses.

However, according to known techniques, three-dimensional information of the obstacle cannot be obtained in a case where the obstacle is detected on the basis of the captured image data taken by the vehicle-mounted camera. Thus, for example, a distance to the obstacle and/or a height of the obstacle is unknown, and therefore, there remains room for improvement in terms of accuracy.

For example, the known techniques include JP2009-114783A (which will be herein after referred to as Patent reference 1), Raul Mur-Artal, J. M. M. Montiel, and Juan D. Tard os, “ORB-SLAM: A Versatile and Accurate Monocular SLAM System”, [online], IEEE TRANS ACTIONS ON ROBOTICS, VOL. 31, NO. 5, OCTOBER 2015 1147, [search on Mar. 25, 2020], Internet <URL:https://ieeexplore.ieee.org/stamp/stamp.jsp?arnumber=7219438#search=%27ORBSLAM%3A+A+Versatile+and+Accurate+Monocular%27> (which will be hereinafter referre d to as Non-patent reference 1), Richard A. Newcombe, Steven J. Lovegrove and Andrew J. Davison, “DTAM: Dense Tracking and Mapping in Real-Time”, [online], [search on Mar. 25, 2020], Internet <URL: https://www.doc.ic.ac.uk/-ajd/Publications/newcombe_etal_iccv2011.pdf#search=%27DTAM%3ADense+Tracking+and+Mapping+in+RealTime+Richard %27> (which will be hereinafter referred to as Non-patent reference 2), Jakob Engel and Thomas Schops an d Daniel Cremers, “LSD-SLAM: Large-Scale Direct Monocular SLAM”, [online], [search on Mar. 25, 2020], Internet <URL: http://search.yahoo.co.jp/r/FOR=sEyckuxV3ijU1h3e90vqbkcvlTw goBVQKuRGoH8yCUYcHr_gPfj2bLOsSchwZAtOul2nh6UL9y79jhdSr_FdDolfyQZ6RHNLCyvDCGj.EYRcfN..d9kcBqsb8ln5O9ynLFDxvdsYGFniX9xRMLhA4TLjAyOkpqEOO3Zc2qkWSau4bz14A5259ir2L6tnJC6yQS9uDf7CjccDqStMZtscqkyoW7zhHPt9ECMZDABINneuQ5jt2yEOqEooQ--/_ylt=A2Ri4yKhAXteNyoAoZGDTwx.;_ylu=X3oDMTBtNHJhZXRnBHBvcwMxBHNIYwNzcgRzbGsDdGIObGU-/SIG=14k2d3t9d/EXP=1585220449/**https %3A//vision.in.tum.de/_media/spezial/bib/engel14eccv.pdf%23search=%27LSDSLAM%253A%2BLargeScale%2BDirect %2BMonocular %2BSLAM %27> (which will be hereinafter referred to as Non-patent reference 3), and Henri Rebecq et al., “EMVS: Event-Based Multi-View Stereo-3D Reconstruction with an Event Camera in Real-Ti me”, [online], [search on Mar. 25, 2020], Internet <URL: http://rpg.ifi.uzh.ch/docs/IJCV17_Rebecq.pdf#search=%27EMVS %3A+EventBased+MultiView+Stereo%E2%80%943D+Reconstruction+with+an+Event+Camera+in+RealTime+PDF%27> (which will be hereinafter referred to as N on-patent reference 4).

A need thus exists for an obstacle detection apparatus, an obstacle detection method, and program, which are not susceptible to the drawback mentioned above.

### SUMMARY

According to an aspect of this disclosure, an obstacle detection apparatus includes an operation control portion configured to control operation of a movable portion at a door of a vehicle, and a first obtaining portion configured to obtain captured image data of a vicinity of the door of an outer side of the vehicle from an imager provided at the movable portion. The captured image data includes at least first captured image data when the movable portion is in a first state and second captured image data when the movable portion has moved from the first state and is in a second state. The apparatus includes a second obtaining portion configured to obtain moving amount information of the movable portion from the first state to the second state, an imager position calculation portion configured to calculate imager position information including a position of the imager when the movable portion is in the first state and a position of the imager when the movable portion is in the second state, on the basis of the moving amount information, and an obstacle position calculation portion configured to calculate a three-dimensional position of an obstacle included in the first captured image data and in the second captured image data, on the basis of the first captured image data, the second captured image data and the imager position information.

According to another aspect of this disclosure, an obstacle detection method includes an operation controlling step of controlling operation of a movable portion at a door of a vehicle, a first obtaining step of obtaining captured image data of a vicinity of the door at an outer side of the vehicle from an imager provided at the movable portion, the captured image data including at least first captured image data when the movable portion is in a first state and second captured image data when the movable portion has moved from the first state and is in a second state, a second obtaining step of obtaining moving amount information of the movable portion from the first state to the second state, an imager position calculating step of calculating imager position information including a position of the imager when the movable portion is in the first state and a position of the imager when the movable portion is in the second state, on the basis of the moving amount information, and an obstacle position calculating step of calculating a three-dimensional position of an obstacle included in the first captured image data and in the second captured image data, on the basis of the first captured image data, the second captured image data and the imager position information.

According to another aspect of this disclosure, a computer-readable storage medium stores a computer-executable program and the program includes causing a computer to perform an operation controlling step of controlling operation of a movable portion at a door of a vehicle, a first obtaining step of obtaining captured image data of a vicinity of the door at an outer side of the vehicle from an imager provided at the movable portion, the captured image data including at least first captured image data when the movable portion is in a first state and second captured image data when the movable portion has moved from the first state and is in a second state, a second obtaining step of obtaining moving amount information of the movable portion from the first state to the second state, an imager position calculating step of calculating imager position information including a position of the imager when the movable portion is in the first state and a position of the imager when the movable portion is in the second state, on the basis of the moving amount information, and an obstacle position calculating step of calculating a three-dimensional position of an obstacle included in the first captured image data and the second captured image data, on the basis of the first captured image data, the second captured image data and the imager position information.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating a passenger compartment of a vehicle of a first embodiment disclosed here in a state where a part thereof is seen through;

FIG. 2 is a plane view (overhead view) of the vehicle of the first embodiment;

FIG. 3 is a block diagram of a configuration of an obstacle detection system of the first embodiment;

FIG. 4 is a block diagram of a function configuration of a CPU at the vehicle of the first embodiment;

FIG. 5A is a view schematically illustrating a state in which an imager is provided at a door mirror of the vehicle of the first embodiment;

FIG. 5B is another view schematically illustrating a state in which the imager is provided at a door mirror of the vehicle of the first embodiment;

FIG. 6A is a view schematically illustrating a positional relation of the door of the vehicle of the first embodiment and a curb;

FIG. 6B is another view schematically illustrating the positional relation of the door of the vehicle of the first embodiment and a curb;

FIG. 6C is another view schematically illustrating the positional relation of the door of the vehicle of the first embodiment and a curb;

FIG. 7 is a flowchart indicating processing at the CPU of the vehicle of the first embodiment;

FIG. 8A is a view schematically illustrating an installation position of the imager at the door of the vehicle according to a second embodiment disclosed here;

FIG. 8B is a view schematically illustrating an installation position of the imager at another door of the vehicle according to the second embodiment;

FIG. 9 is a block diagram of a configuration of the obstacle detection system of the second embodiment;

FIG. 10 is a flowchart indicating processing at the CPU of the vehicle of the second embodiment;

FIG. 11 is a view schematically illustrating a manner in which two of captured image data, of which visual points differ from each other, are captured while moving at the vehicle of a third embodiment disclosed here; and

FIG. 12 is a flowchart indicating processing at the CPU of the vehicle of the third embodiment.

### DETAILED DESCRIPTION

Hereinafter, exemplary embodiments (a first embodiment to a fourth embodiment) of the present disclosure will be disclosed. Configurations of the disclosure described in the embodiments and actions, operations, results and effects brought by the configurations are merely examples. This disclosure can also be realized by a configuration other than those disclosed in the embodiments described hereinafter, and at least one of various effects and derivative effects based on the basic configurations can be obtained.

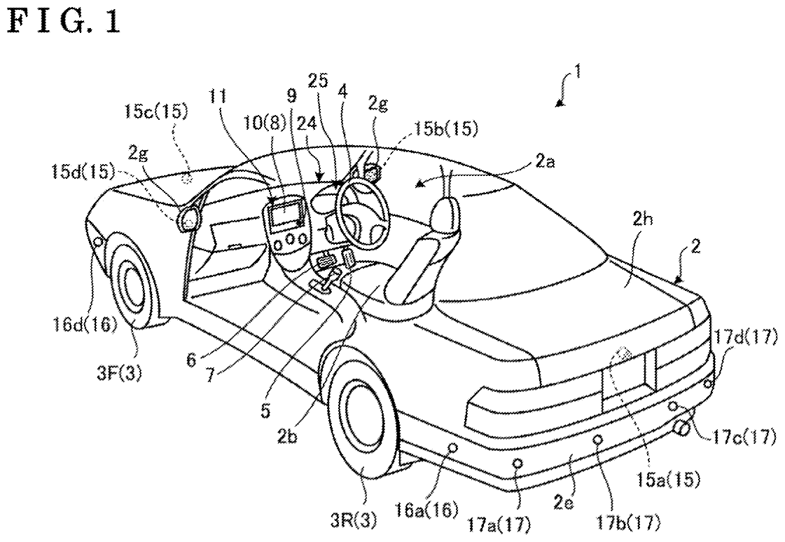

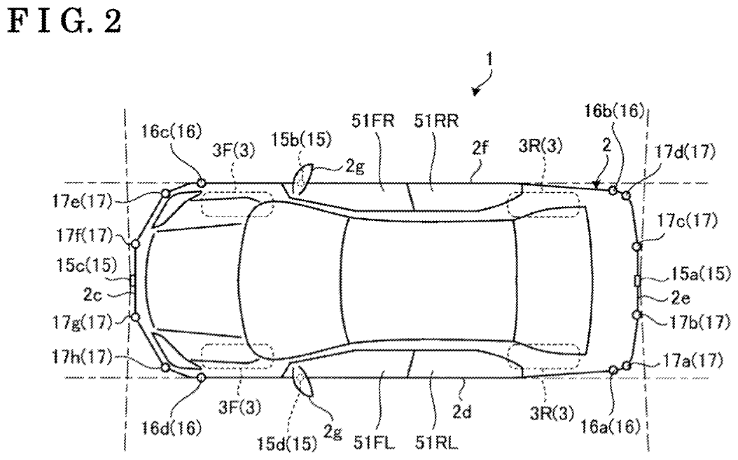

(First embodiment) First, a configuration of a vehicle will be described with reference to FIGS. 1 and 2. FIG. 1 is a perspective view illustrating a passenger compartment of a vehicle 1 of a first embodiment in a state where a part of the cabin is seen through. FIG. 2 is a plane view (overhead view) of the vehicle of the first embodiment.

In the first embodiment, the vehicle 1 may be, for example, an automobile of which a drive source is an internal combustion engine, that is, an internal combustion engine vehicle, may be an automobile of which a drive source is an electric motor, that is, an electric vehicle, a fuel-cell vehicle or the like, may be a hybrid vehicle of which the drive source is both the internal combustion engine and the electric motor, or may be a vehicle having other drive source.

The vehicle 1 can mount various transmissions, and/or can mount various apparatuses such as a system and/or components necessary for driving the internal combustion engine and/or the electric motor. In addition, for example, an apparatus, a method, the number, a layout relating to driving of wheels 3 of the vehicle 1 can be variously set.

As illustrated in FIG. 1, a vehicle body 2 configures a passenger compartment 2a in which occupants are seated. In the passenger compartment 2a, for example, a steering portion 4, an acceleration operation portion 5, a brake operation portion 6, and a shift operation portion 7 are provided in a state of facing a seat 2b of a driver as the occupant.

The steering portion 4 is, for example, a steering wheel protruded from a dashboard 24. The acceleration operation portion 5 is, for example, an accelerator pedal positioned under a foot of the driver. The brake operation portion 6 is, for example, a brake pedal positioned under the foot of the driver. The shift operation portion 7 is, for example, a shift lever protruding from a center console. For example, the steering portion 4, the acceleration operation portion 5, the brake operation portion 6, and the shift operation portion 7 are not limited to those described above.

In addition, a display device 8 as a display output portion and/or an audio output device 9 as an audio output portion are provided in the passenger compartment 2a. The display device 8 is, for example, a liquid crystal display (LCD) and/or an organic electroluminescent display (OELD). The display device 8 is covered with a transparent operation input portion 10 such as a touch panel.

The occupants can visually recognize an image displayed on a display screen of the display device 8 via the operation input portion 10. The occupants can execute an operation input by operations such as touching, pressing and/or moving the operation input portion 10 with a hand and/or a finger on a position corresponding to the image displayed on the display screen of the display device 8. The audio output device 9 is a loud speaker, for example.

For example, the display device 8, the audio output device 9, and the operation input portion 10 are provided on a monitor device 11 positioned on the dashboard 24 at a center portion in a vehicle width direction, that is, a right-and-left direction.

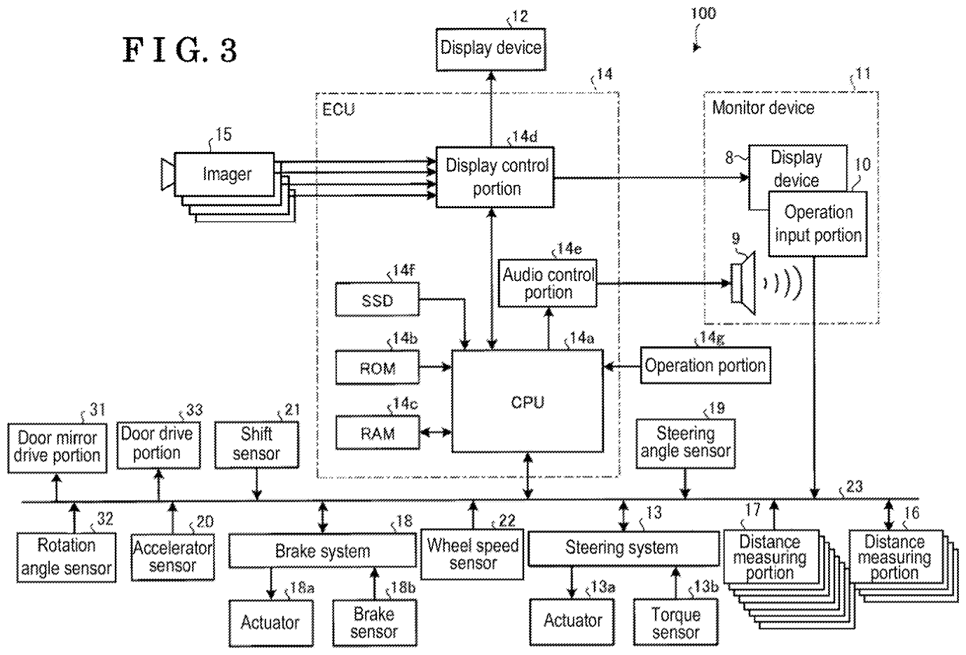

For example, the monitor device 11 can include an operation input portion including a switch, a dial, a joystick, a press button. Another audio output device can be provided at another position in the passenger compartment 2a that is different from the position of the monitor device 11, and/or voice and/or sound can be outputted from the audio output device 9 at the monitor device 11 and other audio output device 9. The monitor device 11 may also be used as, for example, a navigation system and/or an audio system. Another display device 12 (refer to FIG. 3) that is different from the display device 8 is provided in the passenger compartment 2a.

The explanation will be hereinafter made with reference also to FIG. 3. FIG. 3 is a block diagram of a configuration of an obstacle detection system 100 of the first embodiment. As illustrated in FIG. 3 as an example, the vehicle 1 includes a steering system 13 that steers at least two wheels 3. The steering system 13 includes an actuator 13a and a torque sensor 13b. The steering system 13 is electrically controlled by, for example, an electronic control unit (ECU) 14, and operates the actuator 13a. The steering system 13 is configured as, for example, an electric power steering system and/or a steer by wire (SBW) system.

The steering system 13 supplements a steering force by adding torque, that is, assisted torque to the steering portion 4 using the actuator 13a, and/or steers the wheels 3 using the actuator 13a. In this case, the actuator 13a may steer one of the wheels 3 or may steer plural wheels 3. The torque sensor 13b detects, for example, torque applied to the steering portion 4 from the driver.

As illustrated in FIG. 2, for example, four imagers or imaging portions 15a to 15d serving as plural imagers 15 are provided at the vehicle body 2. The imager 15 is a digital camera in which an imaging element such as a charge coupled device (CCD) and/or a CMOS image sensor (CIS) is incorporated. The imager 15 can output moving picture data in a predetermined frame rate. Each of the imagers 15 includes a wide-angle lens or a fish-eye lens and can image a range of, for example, 140 degrees to 190 degrees in the horizontal direction. An optical axis of the imager 15 is set obliquely downward. Accordingly, the imager 15 sequentially images an external environment around or in a vicinity of the vehicle body 2 including a road surface on which the vehicle 1 can move and/or an area in which the vehicle 1 can park, and outputs the image as captured image data.

The imager 15a is positioned, for example, at an end portion 2e on a rear side of the vehicle body 2 and is provided on a wall portion at a lower side of a door 2h of a rear trunk. The imager 15b is positioned, for example, at an end portion 2f on the right side of the vehicle body 2 and is provided at a door mirror 2g (an example of a movable portion) on the right side. The imager 15c is positioned, for example, at an end portion 2c on the front side of the vehicle body 2, that is, the front side in the longitudinal front-and-rear direction of the vehicle body 2 and is provided at a front bumper, for example. The imager 15d is positioned, for example, at an end portion 2d on the left side, that is, the left side in the vehicle width direction of the vehicle body 2 and is provided on a door mirror 2g serving as a protrusion portion on the left side.

The ECU 14 executes calculation processing and/or image processing on the basis of the image data obtained by the plural imagers 15 (the imagers 15a to 15d in the present embodiment), and then, can generate an image of a wider viewing angle and/or generate a virtual overhead view image of the vehicle 1 viewed from above. The overhead view image is referred to also as a plane image.

As illustrated in FIG. 1 and FIG. 2, for example, four distance measuring portions 16a to 16d and eight distance measuring portions 17a to 17h are provided at the vehicle body 2 as plural distance measuring portions 16 and 17. The distance measuring portions 16 and 17 are, for example, sonar that emit ultrasonic waves and catch reflected waves. The sonar is also referred to as a sonar sensor or an ultrasonic detector. The ECU 14 can identify the presence of an object including an obstacle positioned around or in the vicinity of the vehicle 1 and/or can measure a distance to the object, according to a detection result of the distance measuring portions 16 and 17. That is, the distance measuring portions 16 and 17 are an example of a detection portion that detects the object.

In this case, the distance measuring portion 17 is used for detecting, for example, an object in a relatively short distance, and the distance measuring portion 16 is used for detecting, for example, an object in a relatively long distance which is farther than the object to be detected by the distance measuring portion 17. The distance measuring portion 17 is used for detecting an object at the front and rear of the vehicle 1, and the distance measuring portion 16 is used for detecting an object at a side of the vehicle 1.

As illustrated in FIG. 3, in the obstacle detection system 100, in addition to the ECU 14, the monitor device 11, the steering system 13, and the distance measuring portions 16 and 17, a brake system 18, a steering angle sensor 19, an accelerator sensor 20, a shift sensor 21, a wheel speed sensor 22, a door mirror drive portion 31, a rotation angle sensor 32 and a door drive portion 33 are electrically connected to each other via an in-vehicle network 23 serving as an electric telecommunication line, for example. The in-vehicle network 23 is configured, for example, as a controller area network (CAN).

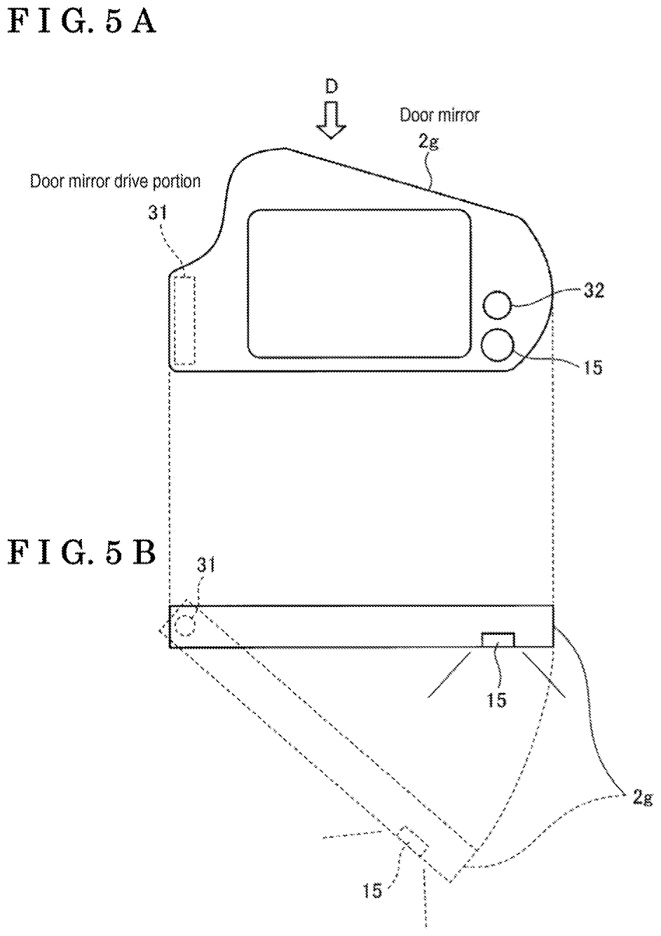

The door mirror drive portion 31 causes the door mirror 2g to rotationally move about a predetermined rotation axis (refer to FIG. 5). The rotation angle sensor 32 detects a rotation angle of the door mirror 2g and outputs rotation angle information (refer to FIG. 5). For example, the rotation angle sensor 32 is a gyroscope sensor provided at a position that is substantially same as a position of the imager 15. The door drive portion 33 causes a door 51 (doors 51FR, 51RR, 51FL, 51RL, refer to FIG. 2) to rotationally move about a predetermined rotation axis.

With the above-described configuration, the ECU 14 transmits a control signal via the in-vehicle network 23, thereby controlling, for example, the steering system 13, the brake system 18, the door mirror drive portion 31 and the door drive portion 33. The ECU 14 can receive detection results of the torque sensor 13b, a brake sensor 18b, the steering angle sensor 19, the distance measuring portion 16, the distance measuring portion 17, the accelerator sensor 20, the shift sensor 21, the wheel speed sensor 22 and the rotation angle sensor 32, and/or operation signals of the operation input portion 10, for example.

The ECU 14 includes, for example, a central processing unit (CPU) 14a, a read only memory (ROM) 14b, a random access memory (RAM) 14c, a display control portion 14d, an audio control portion 14e, a solid state drive (SSD) (flash memory) 14f and an operation portion 14g performing an instruction input operation to the ECU 14.

In the above-described configuration, the CPU 14a is configured to perform image processing related to the image displayed on the display devices 8 and 12, and/or various calculation processing including automatic control of the vehicle 1, release of the automatic control, and/or the detection of the obstacle, for example.

The CPU 14a is configured to read out program installed and stored in a non-volatile storage device including the ROM 14b, and to execute the calculation processing according to the program. The RAM 14c temporarily stores various data used for the calculation by the CPU 14a.

The display control portion 14d mainly performs the image processing using the image data obtained at the imager 15 and/or the composition of the image data to be displayed on the display device 8, among the calculation processing performed at the ECU 14.

The audio control portion 14e mainly executes processing of audio data to be outputted from the audio output device 9 among the calculation processing performed at the ECU 14.

The SSD 14f is a rewritable non-volatile storage unit, and is configured to store data even in a case where the power of the ECU 14 is turned off. For example, the CPU 14a, ROM 14b and/or RAM 14c can be integrated in one package.

For example, the ECU 14 may be configured to use other logical operation processor and/or other logic circuit including a digital signal processor (DSP), instead of the CPU 14a. A hard disk drive (HDD) may be provided instead of the SSD 14f, and the SSD 14f and/or the HDD may be provided separately from the ECU 14.

The brake system 18 is configured as, for example, an anti-lock brake system (ABS) that suppresses locking of the brake, an electronic stability control (ESC) that suppresses skidding of the vehicle 1 at the time of cornering, an electric brake system that enhances the braking force (executes a braking assist), and/or a brake by wire (BBW).

The brake system 18 gives a braking force to the wheels 3, and eventually to the vehicle 1 via an actuator 18a. The brake system 18 is configured to detect locking of the brake, idling of the wheels 3, and/or signs of skidding from the rotation difference between the right and left wheels 3, and to execute various controls including traction control, stability control of the vehicle, skidding prevention control, for example. The brake sensor 18b is, for example, a sensor that detects a position of a movable portion of the brake operation portion 6. The brake sensor 18b is configured to detect the position of the brake pedal serving as the movable portion of the brake operation portion 6. The brake sensor 18b includes a displacement sensor.

For example, the steering angle sensor 19 is a sensor that detects an amount of steering of the steering portion 4 such as the steering wheel. The steering angle sensor 19 is configured using, for example, a hall element. The ECU 14 acquires, from the steering angle sensor 19, the amount of steering of the steering portion 4 by the driver and/or an amount of steering of each of the wheels 3 in a case of automatic steering, and executes various controls. The steering angle sensor 19 detects a rotation angle of a rotating part included in the steering portion 4. The steering angle sensor 19 is an example of an angle sensor.

The accelerator sensor 20 is, for example, a sensor that detects a position of a movable portion of the acceleration operation portion 5. The accelerator sensor 20 is configured to detect the position of the accelerator pedal serving as the movable portion of the acceleration operation portion 5. The accelerator sensor 20 includes a displacement sensor.

The shift sensor 21 is, for example, a sensor that detects a position of a movable portion of the shift operation portion 7. For example, the shift sensor 21 is configured to detect positions of a lever, an arm and a button, which serve as the movable portions of the shift operation portion 7. The shift sensor 21 may include a displacement sensor or may be configured as a switch.

The wheel speed sensor 22 is a sensor that detects an amount of rotation of the wheels 3 and/or the number of rotations of the wheels 3 per unit time. The wheel speed sensor 22 outputs, as a sensor value, the number of the wheel speed pulses indicating the detected number of rotations. The wheel speed sensor 22 is configured using, for example, the hall element. For example, the ECU 14 calculates an amount of movement of the vehicle 1 on the basis of the sensor value acquired from the wheel speed sensor 22, and executes various controls. In some cases, the wheel speed sensor 22 is provided at the brake system 18. In this case, the ECU 14 acquires the result of detection by the wheel speed sensor 22 via the brake system 18.

The configuration, the arrangement and/or the electrical connection form of various sensors and the actuators described above are examples, and can be variously set (changed).

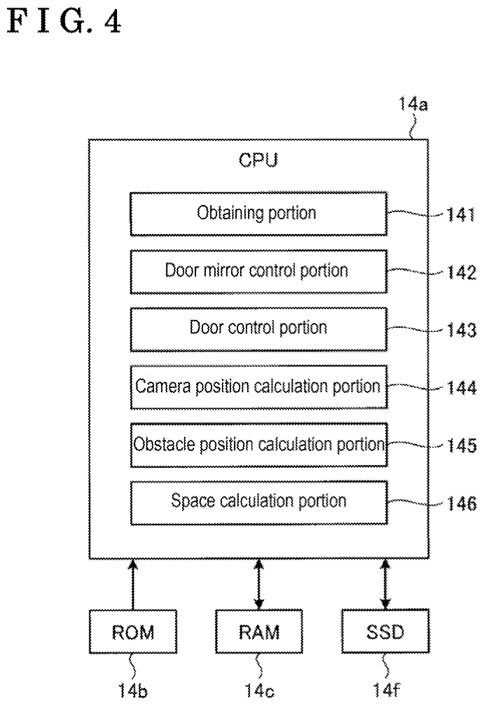

Next, the function configuration of the CPU 14a at the vehicle 1 of the first embodiment will be described with reference to FIG. 4. FIG. 4 is a block diagram of the function configuration of the CPU 14a of the vehicle 1 according to the first embodiment. The CPU 14a includes an obtaining portion 141, a door mirror control portion 142, a door control portion 143, a camera position calculation portion 144, an obstacle position detection portion 145 and a space detection portion (space calculation portion) 146, which serve as function modules. Each of the function modules is realized in a manner that the CPU 14a reads out the program stored in the storage device including the ROM 14b and executes the program. Among the processing performed by the CPU 14a, other processing than the processing performed by any of the portions 141 to 146 will be explained by using “the CPU 14a” as the performer of the processing.

Here, a state in which the imager 15 is provided at the door mirror 2g on the vehicle 1 will be described with reference to FIGS. 5A and 5B schematically illustrating the state in which the imager 15 is provided at the door mirror 2g on the vehicle 1 according to the first embodiment. The imager 15 is provided at the door mirror 2g to be positioned away from the door mirror drive portion 31 provided at the position same as the position of the rotation axis extending in the vertical direction. Accordingly, plural captured image data including large difference of the viewpoints between the plural captured image data are obtained when the door mirror 2g is rotationally moved (the details will be described below).

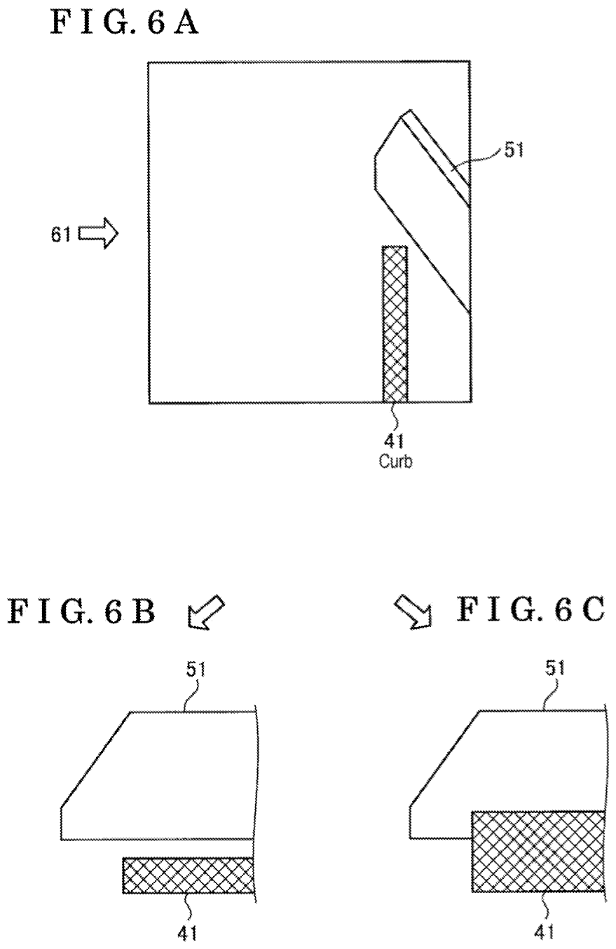

Next, each of FIGS. 6A, 6B and 6C is a view schematically illustrating a positional relation of the door 51 of the vehicle 1 of the first embodiment and a curb 41. Suppose that an image including the door 51 and the curb 41 is captured or taken by the imager 15, as illustrated in FIG. 6A. The positional relations of the door 51 and the curb 41 include a case in which a height of a bottom surface of the door 51 is higher than the curb 41 as illustrated in FIG. 6B (which is a view seen in a direction 61 of FIG. 6A) and a case in which the height of the bottom surface of the door 51 is lower than the curb 41 as illustrated in FIG. 6C (which is another view seen in the direction 61 of FIG. 6A).

However, detailed three-dimensional position information including, for example, a height of the curb 41 cannot be obtained through ordinary processing from the image illustrated in FIG. 6A. Accordingly, the known technique is on the safe side and makes the opening movement of the door 51 stop before the curb 41 even in a case where the height of the bottom surface of the door 51 is actually higher than the curb 41 (FIG. 6B), which may make the user feel uncomfortable. Thus, it is ideal that the door 51 is opened and closed on the basis also of a three-dimensional position of the obstacle (the curb 41), considering convenience of the user. The highly-accurate calculation of the three-dimensional position of the obstacle will be described in detail below.

Referring to FIG. 4, the obtaining portion 141 (a first obtaining portion, a second obtaining portion) obtains various data from each of the configurations. For example, the obtaining portion 141 obtains the captured image from the imager 15. Specifically, the obtaining portion 141 obtains at least first captured image data and second captured image data, which serve as the captured image data of surroundings of the vehicle (a vicinity of the door at an outer side of the vehicle), from the imager 15 provided at the door mirror 2g. The first captured image data corresponds to image data when the door mirror 2g is in a first state (for example, the state indicated by the solid line in FIG. 5B that is seen from a direction D of FIG. 5A). The second captured image data corresponds to image data when the door mirror 2g is in a second state (for example, the state indicated by the dash line in FIG. 5B) after the door mirror 2g moved from the first state.

The obtaining portion 141 obtains, from the rotation angle sensor 32, moving amount information (the rotation angle information, for example) of the door mirror 2g from the first state to the second state. For example, the rotation angle information includes only the rotation angle where the rotation axis corresponds to the vertical direction.

The door mirror control portion 142 controls the door mirror drive portion 31 and thereby causing the door mirror 2g to perform the rotational movement.

Explanation will be made to a position and a posture (a direction of a lens) of the imager 15 (the camera). A position T of the imager 15 at the door 51 may be expressed as the position T (tx, ty, tz). A posture R of the imager 15 may be expressed by a rotational matrix using a rotation angle about an x-axis, a y-axis and a z-axis, and be expressed by parameter of R (Φ, ψ, θ). The tx is a value of the x-coordinate, the ty is a value of the y-coordinate and the tz is a value of the z-coordinate, in a predetermined space coordinate in which the z-axis is the vertical direction. The Φ is a value of a rotation angle of which the rotation axis is the x-axis, the ψ is a value of a rotation angle of which the rotation axis is the y-axis and the θ is a value of a rotation angle of which the rotation axis is the z-axis.

The position (a locus) of the imager 15 can be expressed only by a rotation angle θ of the door mirror 2g. The rotation axis of the door mirror 2g is the z-axis direction and the z-coordinate of the imager 15 does not change even when the door mirror 2g moves, and therefore an explanation will be made below on the x-coordinate and the y-coordinate of the positon of the imager 15.

When an initial position of the imager 15 is T0 (tx0, ty0), the position of the imager 15 can be calculated from a formula (1) as follows.

$$\begin{matrix}( Formula 1 ) & \\ [ \begin{matrix}tx \\ ty\end{matrix} ] = [ \begin{matrix}cos θ & - sin θ \\ sin θ & cos θ\end{matrix} ] [ \begin{matrix}tx 0 \\ ty 0\end{matrix} ] & Formula ( 1 )\end{matrix}$$

In particular, when a length from the rotation axis to the imager 15 is a length L and the initial position of the imager 15 is T0 (0, L), the position of the imager 15 is T (−L sin θ, L cos θ).

The posture of the imager 15 can be calculated from a calculation similar to the calculation of the position of the imager 15.

According to a self-localization (estimation of a position of a camera) in a known technique of vSLAM, the position and posture of the camera are expressed with six parameters including a three dimensional coordinate x, y, z, and ψ, Φ, θ that correspond to the angle at each of the rotation axes. Here, the vSLAM is a method of estimating the position of a camera itself and the three-dimensional positions of the surroundings, by capturing images of plural viewpoints and sequentially performing the self-localization (the estimation of the position and posture of the camera) and mapping (estimation of a depth of the photographic subject) while moving the camera. Compared to the vSLAM, the present embodiment does not require much processing load or power because the position and posture of the camera (the imager 15) can be expressed only by the rotation angle θ of the door mirror 2g.

The door control portion 143 controls opening and closing operations of the door 51 of the vehicle 1. The door control portion 143 is used when a door opening and closing function of automatically opening and closing the door 51 of the vehicle 1 is realized or performed.

The camera position calculation portion 144 (an imager position calculation portion) calculates imager position information including the position of the imager 15 when the door mirror 2g is in the first state and the position of the imager 15 when the door mirror 2g is in the second state, on the basis of the rotation angle information of the door mirror 2g. In a case where the rotation angle sensor 32 is a gyroscope sensor and the rotation angle information is information on an angular velocity, the angular velocity can be converted to the rotation angle by time-integrating the angular velocity. The rotation angle information of the door mirror 2g may be information of a rotation angle directly or actually measured with a potentiometer and/or a magnetic sensor which is mounted on a hinge of the rotation axis as the rotation angle sensor 32.

The obstacle position detection portion 145 (an obstacle position calculation portion) calculates the three-dimensional position of the obstacle that is included or appearing in the first captured image data and the second captured image data, on the basis of the first captured image data, the second captured image data and the imager position information. The obstacle position detection portion 145 uses a motion stereo technique, for example. According to the motion stereo technique, a three-dimensional position of a photographic subject is calculated on the principle of triangulation on the basis of images of plural viewpoints.

In order to obtain an accurate three-dimensional depth of the subject, it is ideal that an installation position of the imager 15 is decided such that the difference in viewpoints is large, that is, an amount of on-screen shift (the number of pixels shifted) of a pair of points captured in the images between frames is large. The imager 15 needs to be moved largely to increase the difference of the viewpoints, and accordingly, it is ideal that the imager 15 is more away from the rotation axis.

The vSLAM, which is one of the motion stereo methods, includes a Feature-based method and a Direct-based method, as a framework of the self-localization and the mapping. In the present embodiment, the Feature-based method is used as an example.

In the Feature-based method, feature points are calculated from the images, and the self-localization and the mapping are realized using geometric error. Specifically, feature points of a frame and the previous frame are calculated, and corresponding points of the inter-frame feature points are searched, and the camera posture and position and three-dimensional position of the feature point are estimated in such a manner that the geometric error of the points is minimized.

Here, as the feature point, feature points including Scale-Invariant Feature Transform (SIFT) that is a scale-invariant feature transformation and/or Speeded-Up Robust Features (SURF) may be used, for example.

As the search of the corresponding points, the epipolar constraint may be used, for example.

A camera matrix is obtained by a lens parameter provided at the camera. Generally, the lens parameter of the camera is calibrated and measured when the camera is shipped, and a value that is stored in advance is used. The camera matrix or the matrix inside the camera is used for the search of the corresponding points, for example.

As plural pairs of the corresponding points are obtained via the search of the corresponding points, an equation at unknown numbers x, y and z is written for each of the pairs of the corresponding points. By solving the equations, the three-dimensional position x, y and z of the obstacle is obtained.

Accordingly, as the captured image data to be used, the current (latest) captured image data and one or more captured image data in the past are needed. For example, the captured image data to be used may be the current (latest) captured image data and the captured image data captured one frame before. In addition thereto, the captured image data captured two frames before may also be used, for example.

The space detection portion 146 detects a space portion in which the door 51 can open and close (a door openable and closable space), on the basis of the information including the detection results on the three-dimensional position of the obstacle that is obtained by the obstacle position detection portion 145 and/or the information including the height of the bottom surface of the door 51, for example.

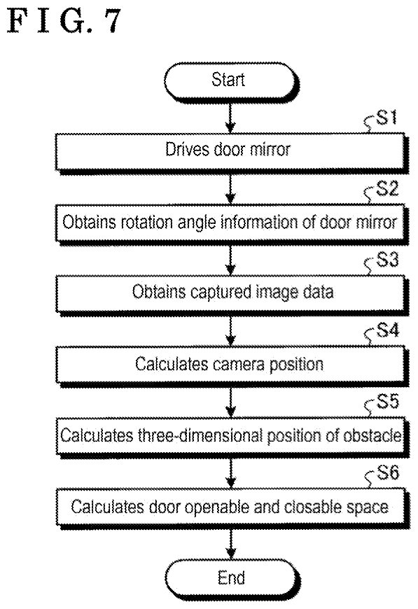

Next, processing at the CPU 14a of the vehicle 1 of the first embodiment will be described with reference to FIG. 7. FIG. 7 is a flowchart indicating the processing at the CPU 14a of the vehicle 1 according to the first embodiment.

First, at Step S1, the door mirror control portion 142 controls the door mirror drive portion 31, thereby causing (driving) the door mirror 2g to rotationally move.

Next, at Step S2, the obtaining portion 141 obtains from the rotation angle sensor 32 the rotation angle information of the door mirror 2g from the first state to the second state.

Next, at Step S3, as the captured image data of the vicinity of the door at the outside the vehicle, the obtaining portion 141 obtains from the imager 15 provided at the door mirror 2g the first captured image data when the door mirror 2g is in the first state (for example, the state indicated by the solid line in FIG. 5B) and the second captured image data when the door mirror 2g moved from the first state and is in the second state (for example, the state indicated by the dash line in FIG. 5B).

Next, at Step S4, the camera position calculation portion 144 calculates the imager position information (the position of the camera) including the position of the imager 15 when the door mirror 2g is in the first state and the positon of the imager 15 when the door mirror 2g is in the second state, on the basis of the rotation angle information.

Next, at Step S5, the obstacle position detection portion 145 calculates the three-dimensional position of the obstacle included in the first captured image data and the second captured image data, on the basis of the first captured image data, the second captured image data and the imager position information.

Next, at Step S6, the space detection portion 146 detects the space portion in which the door 51 is able to be opened and closed, on the basis of information including, for example, the detection results at Step 5. Thereafter, on the basis of the detection results at Step S6 for example, the CPU 14a performs the door opening and closing control and/or the display control of the detection results.

As described above, according to the vehicle 1 of the first embodiment, the three-dimensional position of the obstacle existing around or in the vicinity of the vehicle can be calculated with high accuracy on the basis of the two captured image data that are obtained from the imager 15 provided at the door mirror 2g and that include the different viewpoints from each other. Accordingly, the door 51 itself does not need to move, and thus the three-dimensional position of the obstacle can be calculated with high accuracy at an earlier timing.

Further, the obstacle can be detected on the basis of captured image data by a vehicle-mounted camera that is already mounted for other usage, thereby realizing low costs.

Further, because the door mirror 2g includes an opening and closing (folding) function as a standard feature, there is no need to newly provide a driving portion for the rotational movement of the door mirror 2g, thereby realizing the cost reduction.

On the other hand, according to a known technique, an angle at which a door of the own vehicle can open and close is calculated on the basis of a distance from the door to a white line on a parking area. The technique, however, needs the white line and the obstacle corresponds only to a vehicle, and thus cannot be used in various cases. According to the vehicle 1 of the first embodiment, the three-dimensional position of the obstacle can be calculated highly accurately even in a case where there exists no white line and/or the obstacle corresponds to an object or item other than a vehicle.

(Second embodiment) Next, a second embodiment disclosed here will be explained. In the explanation of the second embodiment, the explanation on the contents similar to the first embodiment will be omitted appropriately. In the second embodiment, the imager 15 is provided at the door 51, at a portion other than the door mirror 2g. That is, in the second embodiment, the movable portion is the door itself and performs the rotational movement about the rotation axis.

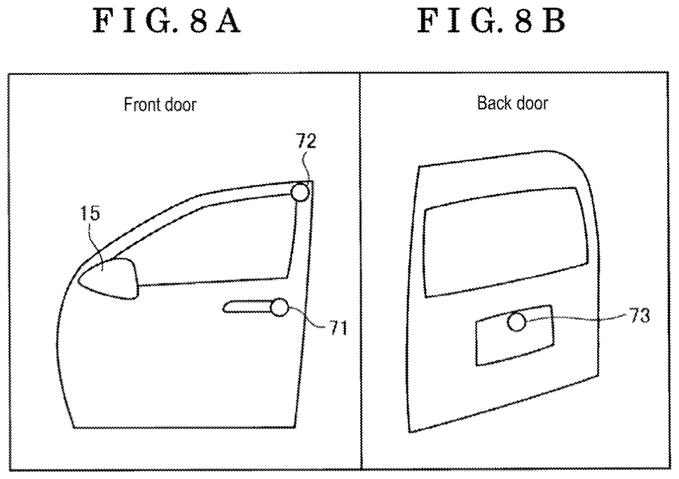

FIGS. 8A and 8B are views each schematically illustrating the installation position of the imager 15 on the door of the vehicle 1 of the second embodiment. As examples of the installation position of the imager 15 at a front door, FIG. 8A shows a position 71 of a handle portion and an upper position 72. As other example of the installation position of the imager 15 at a back door, FIG. 8B shows a position 73 of a handle portion. Similarly to the first embodiment, by providing the imager 15 at a position as far away from the rotation axis as possible, the plural captured image data can be obtained in which the difference in the viewpoints from each other is large.

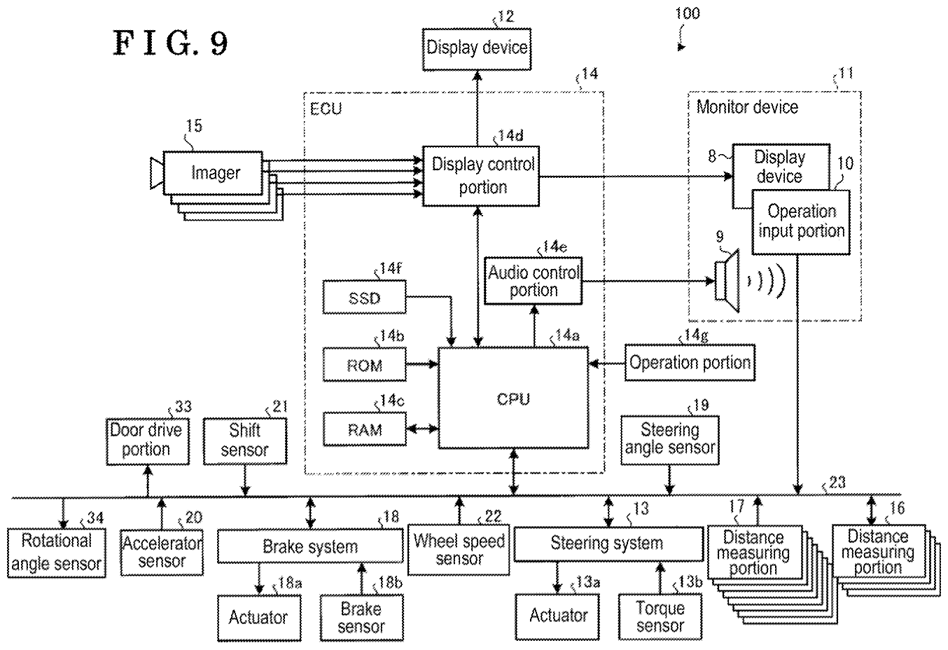

FIG. 9 is a block diagram of a configuration of the obstacle detection system 100 of the second embodiment. Compared to the configuration of FIG. 3, the door mirror drive portion 31 and the rotation angle sensor 32 are not included in the configuration, and a rotational angle sensor 34 is added to the configuration. The rotational angle sensor 34 detects a rotation angle of the door 51 and outputs rotation angle information. For example, the rotational angle sensor 34 is a gyroscope sensor provided at a position that is substantially same as the position of the imager 15. The door drive portion 33 drives the door 51 to rotationally move about a predetermined rotation axis.

The obtaining portion 141 (FIG. 4) obtains rotation angle information of the door which serves as the moving amount information of the door from the first state to the second state. The camera position calculation portion 144 calculates the imager position information including the position of the imager 15 when the door is in the first state and the positon of the imager 15 when the door is in the second state, on the basis of the rotation angle information.

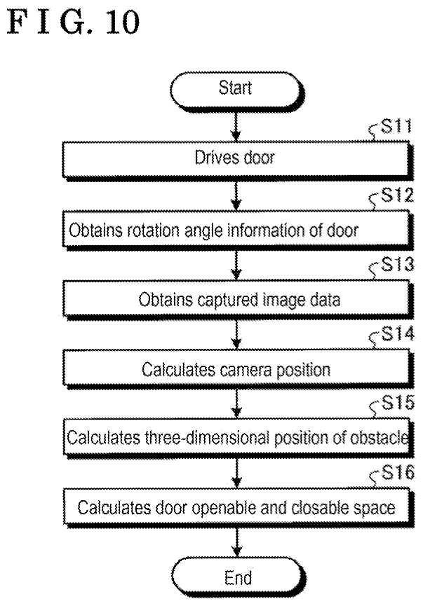

FIG. 10 is a flowchart indicating processing at the CPU 14a of the vehicle 1 of the second embodiment. First, at Step S11, the door control portion 143 controls the door drive portion 33, thereby causing (driving) the door to rotationally move.

Next, at Step S12, the obtaining portion 141 obtains, from the rotational angle sensor 34, the rotation angle information of the door from the first state to the second state.

Next, at Step S13, the obtaining portion 141 obtains, from the imager 15 installed at the door, the first captured image data when the door is in the first state and the second captured image data when the door is in the second state after the door moved from the first state to the second state, which serve as the captured image data in the vicinity of the door at the outer side of the vehicle.

Next, at Step S14, the camera position calculation portion 144 calculates the imager position information (the position of the camera) including the position of the imager 15 when the door is in the first state and the positon of the imager 15 when the door is in the second state, on the basis of the rotation angle information.

Next, at Step S15, the obstacle position detection portion 145 calculates the three-dimensional position of the obstacle captured or included in the first captured image data and the second captured image data, on the basis of the first captured image data, the second captured image data and the imager position information.

Next, at Step S16, the space detection portion 146 detects the space portion in which the door 51 is able to be opened and closed, on the basis of the information including, for example, the detection results at Step 15. Thereafter, on the basis of for example the detection results at Step S16, the CPU 14a performs the door opening and closing control and/or the display control of the detection result.

As described above, according to the vehicle 1 of the second embodiment, by rotationally moving the door itself, the three-dimensional position of the obstacle existing around or in the vicinity of the door 51 at the outer side of the vehicle can be calculated with high accuracy on the basis of the two captured image data that are obtained from the imager 15 provided at the door and that include the different viewpoints from each other.

(Third embodiment) Next, a third embodiment disclosed here will be explained. In the explanation of the third embodiment, the explanation on the contents similar to at least either the first embodiment or the second embodiment will be omitted appropriately. In the third embodiment, the three-dimensional position of the obstacle existing in a range of the door opening and closing operation is stored in advance with the use of technique of the motion stereo method on the basis of image generated by movement of the camera due to movement of the vehicle 1 when running and/or parking. The three-dimensional position of the obstacle is calculated on the basis of the above-explained information and image captured thereafter.

In a case where the imager 15 captures an image while the vehicle 1 is moving, a moving range of the imager 15 is not limited or restricted unlike in a case where the imager 15 captures an image while the door mirror 2g and/or the door 51 is being rotated. Therefore, the position of the imager 15 during the driving may be obtained via integration of plural pieces of information including Global Positioning System (GPS) information, detection results of the wheel speed sensor 22, detection results of the steering angle sensor 19 and detection results of an Inertia Measurement Unit (IMU) sensor (inertia measurement device), for example.

In the self-localization of the known vSLM technique, the position and posture of the camera are expressed with the six parameters including the three-dimensional coordinate x, y, z and tp, D, 6 serving as the angles at the respective rotation axes. This method may be utilized.

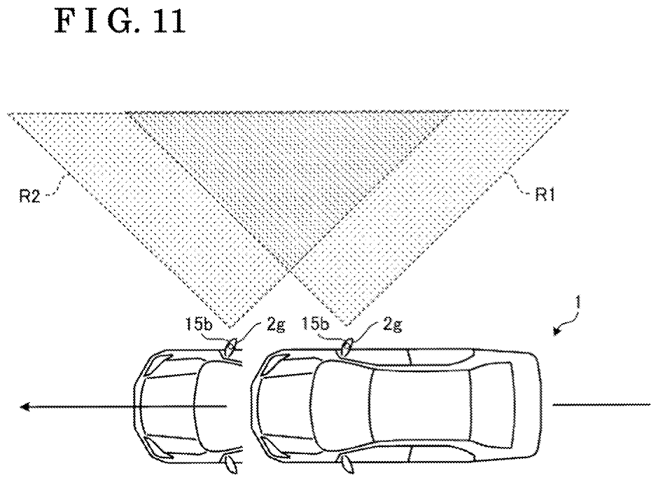

The obtaining portion 141 (FIG. 4) obtains, from the imager 15, at least third captured image data and fourth captured image data which is different from the third captured image data due to that the vehicle 1 has moved. The third captured image data and the fourth captured image data serve as the captured image data of the vicinity of or around the door 51 at the outer side the vehicle 1. Here, FIG. 11 is a view schematically illustrating a manner in which the two captured image data including different visual points from each other are captured while the vehicle of the third embodiment is moving. For example, an image capture range when the third image data is captured is a range R1 and an image capture range when the fourth image data is captured is a range R2.

The obtaining portion 141 obtains second moving amount information indicating an amount of movement of the vehicle from a time at which the third captured image data was captured to a time at which the fourth captured image data was captured.

The camera position calculation portion 144 calculates the imager position information including the position of the imager 15 when the third captured image data was captured and the positon of the imager 15 when the fourth captured image data was captured, on the basis of the second moving amount information.

The obstacle position detection portion 145 calculates the three-dimensional position of the obstacle captured and appearing in the third captured image data and the fourth captured image data, on the basis of the third captured image data, the fourth captured image data and the imager position information.

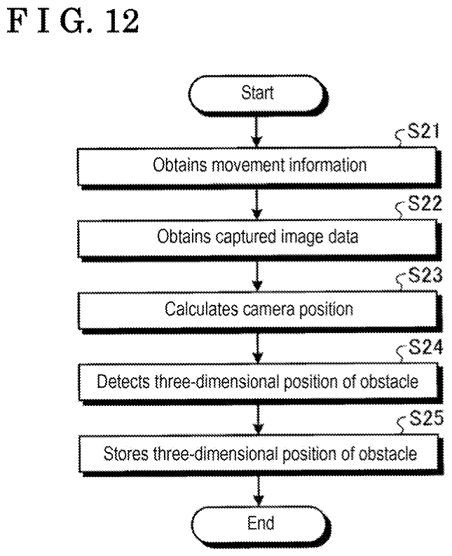

Next, FIG. 12 is a flowchart indicating processing at the CPU 14a of the vehicle 1 of the third embodiment disclosed here. First, at Step S21, the obtaining portion 141 obtains the second moving amount information or movement information indicating the amount of movement of the vehicle from the time at which the third captured image data was captured to the time at which the fourth captured image data was captured.

Next, at Step S22, the obtaining portion 141 obtains, from the imager 15, the third captured image data and the fourth captured image data which is different from the third captured image data because the vehicle has moved. The third captured image data and the fourth captured image data serve as the captured image data of the vicinity of or around the door 51 at the outer side of the vehicle 1.

Next, at Step S23, the camera position calculation portion 144 calculates the imager position information (the position of the camera) including the position of the imager 15 when the third captured image data was captured and the positon of the imager 15 when the fourth captured image data was captured, on the basis of the second moving amount information.

Next, at Step S24, the obstacle position detection portion 145 calculates the three-dimensional position of the obstacle captured and included in the third captured image data and the fourth captured image data, on the basis of the third captured image data, the fourth captured image data and the imager position information. At Step S25, the obstacle position detection portion 145 stores the calculation result, and the date and hour of the calculation.

The calculation result (the three-dimensional position of the obstacle) may be appropriately used in later processing. For example, the detection result is not used in a case where timing of getting-on and/or getting-off the vehicle is largely away from the date and hour of the calculation of the three-dimensional position of the obstacle, because the three-dimensional position of the obstacle may have possibly been changed greatly. For example, when getting-off the vehicle, the calculation result is usually used because the timing of getting-off the vehicle is likely to be close to the timing at which the three-dimensional position of the obstacle was calculated immediately before the parking.

As described above, according to the vehicle 1 of the third embodiment, the three-dimensional position of the obstacle appearing in the captured image data can be highly accurately calculated and stored in advance while the vehicle 1 is moving on the basis of the two captured image data that are obtained from the imager 15 and that include the different viewpoints from each other, and can be utilized for the later obstacle detection processing (the processing of the first embodiment and/or the processing of the second embodiment).

(Fourth embodiment) Next, a fourth embodiment disclosed here will be explained. In the explanation of the fourth embodiment, the explanation on the contents similar to at least any of the first to third embodiments will be omitted appropriately. In the fourth embodiment, an event camera is used as the imager 15. The event camera outputs event data which serves as the capture image data and which includes information of a luminance change per pixel of the subject of imaging.

Differences from the first to third embodiments include the following processing 1 to processing 4.

(Processing 1) Light rays or beams calculation per event With the use of pixel x, y of each event, an occurrence time t thereof, a camera position P at the occurrence time t and a camera matrix (lens parameter), a formula of a ray of light incident of the event is obtained.

(Processing 2) Division of the range of the door opening and closing operation by micro cubes or small cubes

The range of the door opening and closing operation is divided into small cubes, and voxels are generated.

(Processing 3) Count of the number of light rays passing through the small cubes

On the basis of the light rays calculated in each event, the number of the light rays passing through the micro cubes are counted. It can be decided that an obstacle exists in a position of the small cube which includes a large number of light rays.

(Processing 4) Extraction of a space portion which includes a large number of light rays

The coordinate of the small cube in which the number of the light rays is equal to or greater than a predetermined threshold value. The coordinate of the extracted small cube corresponds to a three-dimensional map of the obstacle.

As described above, according to the vehicle 1 of the fourth embodiment, the three-dimensional position of the obstacle existing around the vehicle can be calculated with a higher accuracy via the high-speed photography by using the event camera as the imager 15. For example, the event camera is able to perform the high-speed photography at one million fps (frames per second), and accordingly the three-dimensional position of the obstacle can be calculated highly accurately even in a case where an opening and closing speed of the door mirror 2g and/or the door 51 at which the imager 15 is provided is fast.

Since the event camera or event based camera transmits only the information of the pixel of which the luminance changed, low consumption of electricity can be achieved.

The obstacle detection program executed at the CPU 14a of the embodiments may be configured to be provided as file of an installable format or an executable format by being recorded in a computer-readable recording medium such as a CD-ROM, a flexible disk (FD), a CD-R, or a Digital Versatile Disk (DVD), for example.

The obstacle detection program of the embodiments may be stored in a computer connected to a network including, for example, the Internet and may be configured to be provided by being downloaded via the network. The obstacle detection program may be configured to be provided or distributed via a network including, for example, the Internet.

The above-described embodiments are presented as examples included in the scope of the disclosure without having an intention to limit the scope of this disclosure. For example, an embodiment of the disclosure may include changes or modifications, omissions and/or additions made to at least part of specific usages, structures and configurations, shapes, operations and effects, without departing from the scope of the present disclosure.

According to the aforementioned embodiments, an obstacle detection apparatus includes a door mirror control portion 142 (i.e., an operation control portion) and/or a door control portion 143 (i.e., the operation control portion) configured to control operation of a door mirror 2g (i.e., a movable portion) and/or a door 2h, 51, 51FR, 51RR, 51FL, 51RL (i.e., the movable portion) of a vehicle 1 and an obtaining portion 141 (i.e., a first obtaining portion) configured to obtain captured image data of a vicinity of the door 2h, 51, 51FR, 51RR, 51FL, 51RL of an outer side of the vehicle 1 from an imager 15, 15a, 15b, 15c, 15d provided at the door mirror 2g or at the door 2h, 51, 51FR, 51RR, 51FL, 51RL. The captured image data includes at least first captured image data when the door mirror 2g or the door 2h, 51, 51FR, 51RR, 51FL, 51RL is in a first state and second captured image data when the door mirror 2g or the door 2h, 51, 51FR, 51RR, 51FL, 51RL has moved from the first state and is in a second state. The obstacle detection apparatus includes an obtaining portion 141 (i.e., a second obtaining portion) configured to obtain moving amount information of the door mirror 2g or the door 2h, 51, 51FR, 51RR, 51FL, 51RL from the first state to the second state, and a camera position calculation portion (i.e., an imager position calculation portion) 144 configured to calculate imager position information including a position of the imager 15, 15a, 15b, 15c, 15d when the door mirror 2g orthe door 2h, 51, 51FR, 51RR, 51FL, 51RL is in the first state and a position of the imager 15, 15a, 15b, 15c, 15d when the door mirror 2g or the door 2h, 51, 51FR, 51RR, 51FL, 51RL is in the second state, on the basis of the moving amount information. The obstacle detection apparatus includes an obstacle position detection portion (i.e., an obstacle position calculation portion) 145 configured to calculate a three-dimensional position of an obstacle included in the first captured image data and the second captured image data, on the basis of the first captured image data, the second captured image data and the imager position information.

According to the above-described configuration, the three-dimensional position of the obstacle existing around the vehicle 1 can be calculated with high accuracy on the basis of the two captured image data that are obtained from the imager 15, 15a, 15b, 15c, 15d provided at the door mirror 2g or the door 2h, 51, 51FR, 51RR, 51FL, 51RL and that include the different viewpoints from each other.

According to the aforementioned first embodiment, the movable portion corresponds to the door mirror 2g provided at the door 2h, 51, 51FR, 51RR, 51FL, 51RL and performs rotational movement about a predetermined rotation axis (i.e., a rotation axis). The obtaining portion 141 is configured to obtain rotation angle information of the door mirror 2g, the rotation angle information serving as the moving amount information of the door mirror 2g from the first state to the second state, and the camera position calculation portion 144 is configured to calculate imager position information including a position of the imager 15, 15a, 15b, 15c, 15d when the door mirror 2g is in the first state and a position of the imager 15, 15a, 15b, 15c, 15d when the door mirror 2g is in the second state, on the basis of the rotation angle information.

According to the above-described configuration, the three-dimensional position of the obstacle existing around the vehicle 1 can be calculated with high accuracy on the basis of the two captured image data that are obtained from the imager 15, 15a, 15b, 15c, 15d provided at the door mirror 2g and that include the different viewpoints from each other by rotationally moving the door mirror 2g without moving the door itself.

According to the aforementioned third embodiment, the movable portion corresponds to the door 2h, 51, 51FR, 51RR, 51FL, 51RL and performs rotational movement about a predetermined rotation axis (i.e., a rotation axis). The obtaining portion 141 is configured to obtain rotation angle information of the door 2h, 51, 51FR, 51RR, 51FL, 51RL, the rotation angle information serving as the moving amount information of the door 2h, 51, 51FR, 51RR, 51FL, 51RL from the first state to the second state, and the camera position calculation portion 144 is configured to calculate imager position information including a position of the imager 15, 15a, 15b, 15c, 15d when the door 2h, 51, 51FR, 51RR, 51FL, 51RL is in the first state and a position of the imager 15, 15a, 15b, 15c, 15d when the door 2h, 51, 51FR, 51RR, 51FL, 51RL is in the second state, on the basis of the rotation angle information.

According to the above-described configuration, the three-dimensional position of the obstacle existing around the vehicle 1 can be calculated with high accuracy on the basis of the two captured image data that are obtained from the imager 15, 15a, 15b, 15c, 15d provided at the door 2h, 51, 51FR, 51RR, 51FL, 51RL, and that include the different viewpoints from each other by rotationally moving the door itself.

According to the aforementioned third embodiment, the obtaining portion 141 (i.e., the first obtaining portion) is configured to obtain captured image data of a vicinity of the door 2h, 51, 51FR, 51RR, 51FL, 51RL at the outer side of the vehicle 1 from the imager 15, 15a, 15b, 15c, 15d, and the captured image data includes at least third captured image data and fourth captured image data that is different from the third captured image data due to that the vehicle 1 has moved. The obtaining portion 141 (i.e., the second obtaining portion) is configured to obtain second moving amount information indicating a moving amount of the vehicle 1 from a time at which the third captured image data was captured to a time at which the fourth captured image data was captured. The camera position calculation portion 144 is configured to calculate imager position information including a position of the imager 15, 15a, 15b, 15c, 15d when the third captured image data was captured and a position of the imager 15, 15a, 15b, 15c, 15d when the fourth captured image data was captured, on the basis of the second moving amount information. The obstacle position detection portion 145 is configured to calculate a three-dimensional position of an obstacle included in the third captured image data and the fourth captured image data, on the basis of the third captured image data, the fourth captured image data and the imager position information.

According to the above-described configuration, the three-dimensional position of the obstacle captured in the captured image data can be highly accurately calculated and stored in advance during the movement of the vehicle 1 on the basis of the two captured image data that are obtained from the imager 15, 15a, 15b, 15c, 15d and that include the different viewpoints from each other, and can be utilized for the later obstacle detection processing.

According to the aforementioned fourth embodiment, the imager 15, 15a, 15b, 15c, 15d corresponds to an event camera 15, 15a, 15b, 15c, 15d configured to output, as the captured image data, event data including information of a luminance change per pixel of a subject of imaging.

According to the above-described configuration, the three-dimensional position of the obstacle existing around or in the vicinity of the vehicle 1 can be calculated with even higher accuracy via the high-speed photography with the use of the event camera as the imager 15, 15a, 15b, 15c, 15d.

According to the aforementioned embodiments, an obstacle detection method includes an operation controlling step of controlling operation of a door mirror 2g (i.e., a movable portion) or a door 2h, 51, 51FR, 51RR, 51FL, 51RL (i.e., the movable portion) of a door 2h, 51, 51FR, 51RR, 51FL, 51RL of a vehicle 1 and a first obtaining step of obtaining captured image data of a vicinity of the door 2h, 51, 51FR, 51RR, 51FL, 51RL at an outer side of the vehicle 1 from an imager 15, 15a, 15b, 15c, 15d provided at the door mirror 2g or at the door 2h, 51, 51FR, 51RR, 51FL, 51RL. The captured image data including at least first captured image data when the door mirror 2g or the door 2h, 51, 51FR, 51RR, 51FL, 51RL is in a first state and second captured image data when the door mirror 2g or the door 2h, 51, 51FR, 51RR, 51FL, 51RL has moved from the first state and is in a second state. The obstacle detection method includes a second obtaining step of obtaining moving amount information of the door mirror 2g or the door 2h, 51, 51FR, 51RR, 51FL, 51RL from the first state to the second state and an imager position calculating step of calculating imager position information including a position of the imager 15, 15a, 15b, 15c, 15d when the door mirror 2g or the door 2h, 51, 51FR, 51RR, 51FL, 51RL is in the first state and a position of the imager 15, 15a, 15b, 15c, 15d when the door mirror 2g or the door 2h, 51, 51FR, 51RR, 51FL, 51RL is in the second state, on the basis of the moving amount information. The obstacle detection method includes an obstacle position calculating step of calculating a three-dimensional position of an obstacle included in the first captured image data and in the second captured image data, on the basis of the first captured image data, the second captured image data and the imager position information.

According to the aforementioned embodiments, a computer-readable storage medium stores a computer-executable program, and the program includes controlling operation of a door mirror 2g (i.e., a movable portion) or a door 2h, 51, 51FR, 51RR, 51FL, 51RL (i.e., the movable portion) of a vehicle 1 and obtaining captured image data of a vicinity of the door 2h, 51, 51FR, 51RR, 51FL, 51RL at an outer side of the vehicle 1 from an imager 15, 15a, 15b, 15c, 15d provided at the door mirror 2g or at the door 2h, 51, 51FR, 51RR, 51FL, 51RL. The captured image data including at least first captured image data when the door mirror 2g or the door 2h, 51, 51FR, 51RR, 51FL, 51RL is in a first state and second captured image data when the door mirror 2g or the door 2h, 51, 51FR, 51RR, 51FL, 51RL has moved from the first state and is in a second state. The program includes obtaining moving amount information of the door mirror 2g or the door 2h, 51, 51FR, 51RR, 51FL, 51RL from the first state to the second state and calculating imager position information including a position of the imager 15, 15a, 15b, 15c, 15d when the door mirror 2g or the door 2h, 51, 51FR, 51RR, 51FL, 51RL is in the first state and a position of the imager 15, 15a, 15b, 15c, 15d when the door mirror 2g or the door 2h, 51, 51FR, 51RR, 51FL, 51RL is in the second state, on the basis of the moving amount information. The program includes calculating a three-dimensional position of an obstacle included in the first captured image data and in the second captured image data, on the basis of the first captured image data, the second captured image data and the imager position information.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An obstacle detection apparatus comprising:
an operation control portion configured to control an operation of a movable portion at a door of a vehicle;
a first obtaining portion configured to obtain captured image data of a vicinity of the door of an outer side of the vehicle from an imager provided at the movable portion, the captured image data including at least first captured image data when the movable portion is in a first state and second captured image data when the movable portion has moved from the first state and is in a second state;
a second obtaining portion configured to obtain moving amount information of the movable portion from the first state to the second state;
an imager position calculation portion configured to calculate imager position information including a position of the imager when the movable portion is in the first state and a position of the imager when the movable portion is in the second state, on the basis of the moving amount information; and
an obstacle position calculation portion configured to calculate a three-dimensional position of an obstacle included in the first captured image data and the second captured image data, on the basis of the first captured image data, the second captured image data and the imager position information.

2. The obstacle detection apparatus according to claim 1, wherein
the movable portion corresponds to a door mirror provided at the door and performs rotational movement about a rotation axis,
the second obtaining portion is configured to obtain rotation angle information of the door mirror, the rotation angle information serving as the moving amount information of the door mirror from the first state to the second state, and
the imager position calculation portion is configured to calculate imager position information including a position of the imager when the door mirror is in the first state and a position of the imager when the door mirror is in the second state, on the basis of the rotation angle information.

3. The obstacle detection apparatus according to claim 1, wherein
the movable portion corresponds to the door and performs rotational movement about a rotation axis,
the second obtaining portion is configured to obtain rotation angle information of the door, the rotation angle information serving as the moving amount information of the door from the first state to the second state, and
the imager position calculation portion is configured to calculate imager position information including a position of the imager when the door is in the first state and a position of the imager when the door is in the second state, on the basis of the rotation angle information.

4. The obstacle detection apparatus according to claim 1, wherein
the first obtaining portion is configured to obtain, from the imager, captured image data of a vicinity of the door at the outer side of the vehicle, the captured image data includes at least third captured image data and fourth captured image data that is different from the third captured image data due to that the vehicle has moved,
the second obtaining portion is configured to obtain second moving amount information indicating a moving amount of the vehicle from a time at which the third captured image data was captured to a time at which the fourth captured image data was captured,
the imager position calculation portion is configured to calculate imager position information including a position of the imager when the third captured image data was captured and a position of the imager when the fourth captured image data was captured, on the basis of the second moving amount information, and
the obstacle position calculation portion is configured to calculate a three-dimensional position of an obstacle included in the third captured image data and the fourth captured image data, on the basis of the third captured image data, the fourth captured image data and the imager position information.

5. The obstacle detection apparatus according to claim 1, wherein the imager corresponds to an event camera configured to output, as the captured image data, event data including information of a luminance change per pixel of a subject of imaging.

6. An obstacle detection method comprising:
an operation controlling step of controlling operation of a movable portion at a door of a vehicle;
a first obtaining step of obtaining captured image data of a vicinity of the door at an outer side of the vehicle from an imager provided at the movable portion, the captured image data including at least first captured image data when the movable portion is in a first state and second captured image data when the movable portion has moved from the first state and is in a second state;
a second obtaining step of obtaining moving amount information of the movable portion from the first state to the second state;
an imager position calculating step of calculating imager position information including a position of the imager when the movable portion is in the first state and a position of the imager when the movable portion is in the second state, on the basis of the moving amount information; and
an obstacle position calculating step of calculating a three-dimensional position of an obstacle included in the first captured image data and the second captured image data, on the basis of the first captured image data, the second captured image data and the imager position information.

7. A computer-readable storage medium storing a computer-executable program, the program comprising causing a computer to perform:
an operation controlling step of controlling operation of a movable portion at a door of a vehicle;
a first obtaining step of obtaining captured image data of a vicinity of the door at an outer side of the vehicle from an imager provided at the movable portion, the captured image data including at least first captured image data when the movable portion is in a first state and second captured image data when the movable portion has moved from the first state and is in a second state;
a second obtaining step of obtaining moving amount information of the movable portion from the first state to the second state;
an imager position calculating step of calculating imager position information including a position of the imager when the movable portion is in the first state and a position of the imager when the movable portion is in the second state, on the basis of the moving amount information; and
an obstacle position calculating step of calculating a three-dimensional position of an obstacle included in the first captured image data and the second captured image data, on the basis of the first captured image data, the second captured image data and the imager position information.
